(19) United States
(12) Patent Application Publication
(10) Pub. No.: US 2010/0247751 A1
(43) Pub. Date: Sep. 30, 2010

(54) PROCESS FOR MANUFACTURING A THERMALLY AND/OR ELECTRICALLY CONDUCTING SOLID

(75) Inventors: Pierre Gros, Colomiers (FR); Jacques Prosdocimi, Tournefeuille (FR)

Correspondence Address: YOUNG & THOMPSON, 209 Madison Street, Suite 500, Alexandria, VA, 22314, US

(73) Assignees: UNIVERSITE PAUL SABATIER TOULOUSE III, Toulouse Cedex 9 (FR); INSTITUT NATIONAL POLYTECHNIQUE DE TOULOUSE, Toulouse Cedex 4 (FR)

(21) Appl. No.: 12/743,839

(22) PCT Filed: Nov. 20, 2008
(86) PCT No.: PCT/FR08/52093

§ 371 Date: May 20, 2010

(30) Foreign Application Priority Data
Nov. 22, 2007 (FR) 0708192

(51) Int. Cl. B05D 5/12; C09K 5/14; H01B 1/18; B05D 3/02

(52) U.S. Cl. 427/122; 252/67; 252/508; 427/397.7

(57) ABSTRACT

A process for manufacturing a thermally and/or electrically conducting solid, in which: at least one doped aqueous dispersion is prepared, the dispersion including a mica powder and at least one dopant powder, these being dispersed in a non-ionic aqueous liquid, each dopant being chosen from graphites, with the exception of unexpanded expandable graphites, the mica representing at least 5% by weight of the solid matter of the dispersion, the dopant(s) representing 1 to 95% by weight of the solid matter of the dispersion and a proportion of each dopant being chosen depending on the desired thermal and electrical conductivities; each doped aqueous dispersion undergoes a forming operation, the proportion by weight of solid matter in the dispersion having been chosen so as to obtain, in the case of the doped aqueous dispersion, a viscosity compatible with the forming technique used; and the doped aqueous dispersion is left to undergo form consolidation, by at least the evaporation of the aqueous phase of the dispersion liquid.

The invention relates to a process for manufacturing a thermally and/or electrically conducting solid.

The invention is applicable in particular to the production of chemical reactors, thermal exchange interfaces, optical selective coatings, electrodes, electricity-conducting coatings, etc., as well as moulded objects of all kinds, having properties of thermal and/or electrical conduction.

In all its versions and in all its applications, the invention aims to provide an extremely simple, inexpensive manufacturing process which yields a solid that has satisfactory properties in terms of thermal and/or electrical conduction. A further object of the invention is to provide a manufacturing process which allows the thermal and electrical conductivities that are obtained to be controlled.

Processes for manufacturing objects or products using expandable or expanded graphite are known. Expandable graphite is a graphite that has been treated by means of an intercalation solution, which inserts itself between the carbon layers of the graphite. Expanded graphite is obtained by exfoliation of an expandable graphite: under the effect of a thermal shock, the intercalation solution of the expandable graphite sublimes, separating the carbon layers of the graphite.

Among the processes that use expandable graphite, a distinction is made between:
processes in which the graphite is retained in its expandable form. Such processes are used exclusively to manufacture intumescent objects or products, which is not the object of the invention. When such objects or products are exposed to fire, the expandable graphite they contain exfoliates, forming a smoke-tight, heat insulating layer;
processes during which the expandable graphite is converted into expanded graphite by exfoliation within a mould. Such processes are employed to manufacture moulded objects. U.S. Pat. No. 5,288,429 describes a process in which: expandable graphite is mixed with a liquid in order to obtain a moist mixture; the moist mixture is then introduced into a mould, which is heated to a temperature higher than 180° C. (and preferably of the order of 600° C.). The moist mixture can also contain vermiculite as additive. As it exfoliates, the graphite fills the mould (its volume can be multiplied by 800) and forms into a structure by compression against the walls of the mould. The moulded objects so obtained have a low weight, high heat and fire resistance, good mechanical stability, correct electrical conductivity, electromagnetic shielding properties. However, the process described by U.S. Pat. No. 5,288,429 has the following disadvantages: it requires the use of a factory mould manufactured specifically for the object with the desired dimensions and forms; in addition, the mould must be capable of withstanding the step of heating at elevated temperature which is necessary for the exfoliation of the graphite within it. These constraints add considerably to the production cost of the objects moulded according to U.S. Pat. No. 5,288,429.

It is an object of the invention to propose a process for manufacturing moulded objects which is extremely simple and inexpensive. Another object of the invention is to offer the possibility of producing an object moulded “in situ”, that is to say moulded directly in the device that is ultimately to receive it, without the object having to be manufactured beforehand with the aid of a factory mould.

Among the processes that employ expanded graphite, a distinction is made between:
processes in which the expanded graphite is combined with a polymeric organic binder such as a phenolic, epoxy, cellulose or styrene binder, hardening of which requires a curing step. Not only do these processes have the above-mentioned disadvantages (necessary use of a factory mould, curing step, etc.) and use toxic and/or non-recyclable products, they also, and especially, generally yield thermally and electrically insulating products. In this respect, U.S. Pat. No. 6,384,094 recommends adding expanded graphite to a suspension of expandable styrene polymers during polymerization in order to reduce the thermal conductivity of the polystyrene obtained;
processes in which the expanded graphite is consolidated by compression, such as the process described by FR 2 715 082, which is discussed hereinbelow. Because they include compression steps, these processes do not allow objects to be produced “in situ”. The production of objects of a complex form is technically impossible or is not very profitable financially (it being necessary to manufacture blanks specifically for each form);
processes which combine the above two techniques (use of an organic binder and compression). These processes simultaneously have the disadvantages of both techniques.

As indicated above, the invention is applicable especially to the production of chemical reactors and in particular to the production of a composite block for a chemical heat pump. FR 2 715 082 mentioned above describes a process for producing a porous active composite block for a chemical heat pump, which block is composed of a support and an active agent. According to this known process, expanded graphite and an exfoliated lamellar compound such as vermiculite are mixed; the mixture is compressed to form a porous solid support having a graphite density of from 0.03 to 0.5; the support is impregnated with active agent. The composite block so obtained is then either introduced into a heat exchanger circuit or placed inside a vessel and drilled with channels for receiving heat exchanger tubes carrying a heat exchange fluid. When the heat pump is in operation, a gas passes through the composite block, which gas reacts with the active agent (which can be a salt) or is adsorbed thereby (the active agent is in this case a zeolite, for example). The chemical reaction or physical adsorption is exothermic, and the heat given off is conducted by the compressed expanded graphite present in the support. Because it includes a compression step, the process described by FR 2 715 082 does not allow an active composite block to be produced “in situ”, that is to say directly inside a heat pump element, for example. The active block must be manufactured beforehand, with the forms and dimensions of the element that is to receive it, and then introduced into that element. Furthermore, only a small amount of active agent can be absorbed into the composite block (owing to the compression, the block is relatively dense), and the amount of active agent actually absorbed is difficult to control.

An object of the invention is to propose a process for manufacturing a chemical reactor which is extremely simple, can be carried out “in situ” and yields a reactor which can include an amount of active agent that is precisely controlled and, if necessary, is considerable.

The invention is applicable also to the production of a thermal exchange interface between an element that emits heat and an element for recovering and/or evacuating that heat, in a heat exchanger or in an electronic circuit. Known thermal exchange interfaces, which are used in electronic circuits especially for evacuating the heat dissipated by a microprocessor or by a high-power electronic component to a heat sink element, are generally produced from thermal pastes comprising silver particles dispersed in a silicone matrix. Such interfaces offer good thermal conductivity but have the disadvantage of a very high cost.

An object of the invention is to provide a thermal exchange interface which is inexpensive and easy to produce.

The invention is applicable also to the production of electrodes, especially for an electrochemical or bioelectrochemical sensor. An electrode is a system composed of two phases in contact, namely an electronic (and hydrophobic) conductor and an ionic (and hydrophilic) conductor, the interface of which is the site of transfer of charges between the constituents of the two phases. FR 2 860 512 describes a process for producing an electrochemical or bioelectrochemical cell—especially sensor—according to which: a thickness of expanded vermiculite is formed between two thicknesses of expanded graphite, the thickness of vermiculite optionally including crystallized reagents or lyophilized enzymes, the thicknesses of graphite optionally including a catalytic additive (metal or metal oxide, for example); the three thicknesses so formed are compressed simultaneously. Compression allows the three thicknesses formed to be consolidated and bonded together. Each consolidated thickness of graphite, associated with an electrical contact, forms the electronic conductor of an electrode, while the consolidated thickness of vermiculite forms an ion exchange membrane (ionic conductor of the two electrodes). The process described in FR 2 860 512 has the above-mentioned disadvantages of the processes that include a step of consolidation of an expanded graphite by compression, which disadvantages can be remedied by the invention. Also and especially, the process of FR 2 860 512 does not allow electrodes of small thickness (less than 100 μm) to be produced. When the chemical or biochemical reactions involved require catalysts (enzymes, noble metals, etc. incorporated into the vermiculite membrane), relatively large amounts of catalysts are therefore necessary, which adds to the production cost of the cell. Furthermore, when the cell is an electrochemical or bioelectrochemical sensor, the response time and the sensitivity of the sensor are impaired by the distance which must be covered by the chemical species to be analyzed (which is present in the electrolytic solution or in the physiological liquid analyzed) in order to reach the catalyst.

The invention aims to remedy these disadvantages by proposing an extremely simple process which allows an electrode of very small thickness to be produced, in which it is nevertheless possible to immobilize catalysts.

The invention is applicable also to the production of a selective coating for a heliothermal converter or other solar collector. Known heliothermal converters, the purpose of which is to convert solar radiation into heat energy, usually comprise an absorption plate which is made of copper and whose face exposed to solar radiation is treated, in a heavy industrial installation, by anodization with black chrome in order to achieve better optical selectivity (ratio between absorptivity and emissivity for thermal, especially infrared, radiation). Because of its high toxicity, black chrome is nowadays prohibited. Alternative solutions which are respectful of humans and the environment and which are easier to employ are awaited.

An object of the invention is to provide an extremely simple process which allows a non-toxic, ecological coating having satisfactory optical selectivity to be produced.

The invention further aims to propose a process for manufacturing such a conducting solid which also has improved flame-resistance properties, enabling it to be used as a fireproofing barrier.

The invention further aims to propose a process for manufacturing a conducting solid having properties of improved impermeability, especially by rubbing the surface of the conducting solid.

In all its applications and in a preferred version, the invention aims also to propose a manufacturing process which does not use any dangerous or toxic product. Another object of the invention is to provide a wholly recyclable solid. The invention aims also to propose a manufacturing process which does not use any organic product—especially organic solvent or binder. A version of the invention also provides a process which does not use any synthetic product—especially polymeric synthetic product.

In all its applications, the invention relates to a process for manufacturing a thermally and/or electrically conducting solid, in which:
at least one doped aqueous dispersion is prepared, said dispersion comprising a mica powder and at least one dopant powder, which powders are dispersed in a non-ionic aqueous liquid, each dopant being chosen from the graphites, with the exception of unexpanded expandable graphites, the mica representing at least 5 wt. %, especially from 5 wt. % to 99 wt. %, of the solid matter of the dispersion, the dopant(s) representing from 1 wt. % to 95 wt. % of the solid matter of the dispersion, the proportion of each dopant being chosen in dependence on the desired thermal and electrical conductivities,
each doped aqueous dispersion undergoes a forming operation, the proportion by weight of solid matter in the dispersion having been chosen so as to obtain, for the doped aqueous dispersion, a viscosity compatible with the forming technique used,
each doped aqueous dispersion is allowed to consolidate in terms of form, by evaporation at least of the aqueous phase of the dispersion liquid at a temperature below 80° C., in particular at ambient temperature.

It is thus possible to obtain a solid without it being necessary to carry out a step of heating at elevated temperature (in order to cure a binder or exfoliate an expandable compound to obtain consolidation thereof by compression in a mould) or a compression or lamination step. Consolidation of each doped aqueous dispersion is obtained by evaporation of the dispersion liquid (or at least of its aqueous phase), in other words by simple drying, whatever the thickness of dispersion that has been formed. It will be noted that evaporation can be natural or forced (with ventilation for example). It is preferably obtained without heating, that is to say at ambient temperature, especially by drying in the air at ambient temperature. However, it is not out of the question to heat the formed dispersion or the surrounding air slightly in order to accelerate the evaporation. In most of the applications of the invention, however, it is preferable for the doped aqueous dispersion to maintain a temperature below 80° C. during the consolidation step, in order to avoid boiling of its aqueous phase (such boiling altering the structure and appearance of the solid obtained).

The consolidation further has the advantage of taking place substantially at constant volume. The inventors attribute this phenomenon a posteriori solely to the mica powder which, according to them, forms a cohesive network as the dispersion liquid evaporates. They have established that correct structuring could only be obtained if, on the one hand, flocculation of the dispersion was avoided by the use of a non-ionic dispersion liquid and, on the other hand, an amount of mica powder greater than or equal to 5 wt. %, based on solid matter, was incorporated into the dispersion.

This consolidation without compression, lamination or curing allows a solid to be produced “in situ”, directly in the device that is ultimately to receive it. Because the material that forms the solid is introduced into the device in the form of a liquid to pasty aqueous dispersion, it is possible to produce a solid of any form.

Also and especially, the consolidation of each doped aqueous dispersion is obtained even when the dopant it contains is an expanded graphite. Accordingly, the invention for the first time provides a solid based on expanded graphite in which the expanded graphite is neither recompressed nor combined with an organic binder. Because the graphite remains in expanded form, the solid obtained has a low density, which is desirable in many applications.

The invention also provides for the first time a thermally and/or electrically conducting solid based on mica and a dopant, especially a graphite-based dopant, which is free of any organic binder or compound.

Whatever the chosen dopant(s), the process according to the invention is particularly simple and economical. It will be noted that graphites are particularly suitable owing to their low cost.

The solid obtained according to the invention is thermally and/or electrically conducting according to the dopant(s) used. This result was not foreseeable given the thermally and electrically insulating nature of mica. Furthermore, the previously known solids comprising graphite in expanded, non-recompressed form (the graphite is in this case combined with an organic binder) are generally thermal and electrical insulators. The inventors could therefore not anticipate the conducting nature of the solid obtained by the process according to the invention.

According to the invention, the proportion—by weight of solid matter—of each dopant added determines the thermal and electrical conductivities of the solid obtained. It is thus possible to alter the properties of said solid depending on the envisaged application.

Advantageously and according to the invention, the mica powder and the dopant powder(s) are dispersed in the non-ionic aqueous medium so as to form the doped aqueous dispersion(s). In particular, the mica powder or the dopant powder(s) is(are) dispersed in the non-ionic aqueous medium so as to form an intermediate dispersion, and the remaining powder(s) is(are) then added to and mixed with said intermediate dispersion to form the doped aqueous dispersion(s). Accordingly, the preparation of each doped aqueous dispersion can be carried out:
either by mixing the mica powder and each doping powder beforehand and then dispersing the resulting pulverulent mixture in the dispersion liquid,
or by dispersing the mica powder or the doping powder in the dispersion liquid so as to form an intermediate dispersion and then adding the remaining powder to the intermediate dispersion and mixing; in the case of a plurality of doping agents, the intermediate dispersion can be formed from one powder or from a plurality of previously mixed powders; if a plurality of powders remain to be added to the intermediate dispersion, they can be mixed prior to being introduced into the intermediate dispersion or they can be introduced into the intermediate dispersion in succession.

Advantageously and according to the invention, demineralized and/or deionized water is used as the dispersion liquid for at least one—and preferably for each—doped aqueous dispersion. Accordingly, the process preferably does not use any organic solvent.

In a preferred version, each doped aqueous dispersion is prepared solely from demineralized water, mica powder and dopant powder(s). Accordingly, the process according to the invention does not use any product that is dangerous or toxic for humans or the environment; moreover, it yields a solid that is wholly recyclable and, where applicable, ecological. In particular, the process according to the invention does not use any organic binder or compound in the manufacture of a thermally and/or electrically conducting solid.

Advantageously and according to the invention, the process also has at least one or more of the following features:
each mica is chosen from the vermiculites—especially the expanded vermiculites (vermiculites expanded under the effect of a thermal shock) and the chemically delaminated vermiculites;
for each doped aqueous dispersion, at least one dopant is chosen from the natural graphites, especially the expanded natural graphites, the synthetic graphites. In particular, at least one dopant is chosen from the group formed by the non-expandable graphites;
the proportion by weight of solid matter in each doped aqueous dispersion is from 5 to 40%. The proportion by weight of solid matter in the dispersion determines the viscosity thereof; the viscosity can therefore be adjusted according to the chosen forming technique;
the proportion by weight of mica in the solid matter of the doped aqueous dispersion is from 5 to 50%, especially from 20% to 50%, in particular close to 40%;
each mica powder used is composed of particles having dimensions of from 1 to 200 μm; in order to facilitate the dispersion, it preferably comprises at least 90% particles smaller than 90 μm and at least 50% particles smaller than 40 μm;
each dopant powder used is composed of particles having dimensions of from 1 to 200 μm. When the dopant is an expanded natural graphite, the graphite is ground so that the powder used preferably comprises at least 90% particles smaller than 60 μm and at least 50% particles smaller than 30 μm.

According to the invention, various forming techniques can be employed to form each doped aqueous dispersion. If a plurality of doped aqueous dispersions are prepared for the manufacture of the solid, they can be formed by the same technique or by different techniques.

According to a first technique, the doped aqueous dispersion (that is to say at least one dispersion of the process) is formed by application of at least one layer of doped aqueous dispersion to a support. Application can be effected by means of a brush, a roller, a sprayer, etc. The proportion of solid matter in the doped aqueous dispersion is adjusted so as to obtain a viscosity compatible with the tool used for the application and with the desired layer thickness.

According to a second technique, the doped aqueous dispersion (that is to say at least one dispersion of the process) is formed by immersing a support in the doped aqueous dispersion. The proportion of solid matter in the dispersion is in this case adjusted so as to obtain a relatively liquid doped aqueous dispersion. A plurality of successive immersions in the same doped aqueous dispersion can be provided.

For these first two forming techniques, it is possible to use a non-stick flat support. The solid obtained is then a sheet, which can be detached from the support after consolidation of the doped aqueous dispersion(s). In order to obtain a sheet having good mechanical strength, each doped aqueous dispersion used preferably comprises at least 25 wt. % mica, based on solid matter.

In a variant, the solid obtained can be a (conducting) coating film which adheres to the support, provided the support used has not received any non-stick finishing treatment that may prevent adhesion of said film.

Such a coating film can be obtained from a single doped aqueous dispersion, with which one or optionally a plurality of layer(s) are formed on the support (by application or by immersion).

In a variant, a plurality of doped aqueous dispersions are prepared and a plurality of layers of doped aqueous dispersions are formed in succession on the support by application (first technique) or by immersion (second technique). In particular:
there are prepared at least one doped aqueous dispersion, called a bonding dispersion, comprising a proportion of mica greater than 50 wt. %—preferably greater than 70 wt. %—based on solid matter, and a doped aqueous dispersion, called a finishing dispersion, comprising a proportion of dopant(s) greater than 50 wt. %—preferably greater than 70 wt. %—based on solid matter;
a plurality of layers of doped aqueous dispersions are formed in succession on the support, the first layer being formed with the bonding dispersion, the last layer being formed with the finishing dispersion.

The bonding layer has a very cohesive structure, which ensures that the coating film adheres to the support. The finishing layer confers the desired properties on the film, not only in terms of thermal and/or electrical conductivity but also in terms of appearance. In order to improve the durability of the coating film still further, an intermediate layer can be formed with a doped aqueous dispersion comprising 50 wt. % mica, based on solid matter.

It will be noted that it is possible to form a layer when the preceding layer is not yet consolidated and/or dry; in a variant, any subsequent layer is not formed until a layer that has been formed is consolidated and/or dry. In addition, it is possible to use different forming techniques (roller application, brush application, etc., immersion) from one layer to another or, alternatively, to use the same technique for all the layers.

The process according to the invention enables coating films to be produced on supports of any nature and shape.

The support can be an absorption face of a heliothermal converter (or other solar collector). In this case, the dopant, or at least one of the dopants, is a graphite, preferably an expanded natural graphite. The thermal conductivity and optical selectivity of the coating film obtained depend on the proportion by weight of graphite, based on solid matter. The optical selectivity of the film can be close to 2 (which is the average optical selectivity of a natural graphite). Furthermore, the coating film obtained is free of toxic or dangerous products and is wholly recyclable. Because the thermal energy absorbed by the manufactured coating film has to be transmitted to the support (absorption face) and then to a fluid (water or heat-exchange fluid) circuit, it is preferable not to provide a bonding layer as defined above, the thermal conductivity of which is poorer. However, this hypothesis is not ruled out (since the performances of the heliothermal converter remain acceptable).

The support can be an electrical contact. The coating film obtained constitutes an electrode, called a thin electrode, which can advantageously be used in an electrochemical or bioelectrochemical sensor (oxygen sensor, cell for measuring the blood glucose level, etc.). The mica contained in the film forms a hydrophilic ion exchange skeleton, while the dopant serves to transport electrons between the skeleton and the electrical contact. Because the mica and the dopant are in the form of particles of small dimensions which are mixed with one another, the exchange surface between the mica—the ionic conductor of the electrode—and the dopant—the electronic conductor of the electrode—is large, which promotes exchanges. Furthermore, it is possible to manufacture a very fine thin electrode, especially having a thickness less than 100 μm, in which the electrolytic solution (in the case of an electrochemical sensor) or the physiological liquid (in the case of a bioelectrochemical sensor) diffuses easily, all the more so since the film has not undergone compression. A sensor using such an electrode therefore provides a very rapid response and great sensitivity. Furthermore, given its small volume, the thin electrode according to the invention requires, for its operation, a far smaller amount of catalyst (enzymes, noble metals, etc.) than do the known previous electrodes. It is consequently much less expensive than those electrodes. It will be noted that, in order to promote electronic exchanges between the manufactured coating film (thin electrode) and the support (contact), it is preferable not to provide a bonding layer as defined above, the electrical conductivity of which is poorer. However, this hypothesis is not ruled out (since the performances of the electrode remain acceptable).

It will also be noted that the contact serving as support can be solid (the electrode in this case produces a kind of encapsulation of the contact, which can be formed by immersion, for example) or thin (contact produced by screen printing of a fine layer of gold or another conducting metal on any support, for example on a sheet of polyester or polyethylene terephthalate). In order to produce a thin electrode, it is also possible to use any support, especially a non-conducting support (such as a sheet of polyethylene terephthalate), and then bring the coating film produced according to the invention into electrical contact with the support using a contact of the crocodile clip type, for example.

In a variant, the support can be an artistic object, especially a purely artistic object such as a sculpture, or an item of furniture called a decorative item, such as a decorative radiator (a radiator for heating a room of a building but which has an aesthetic form and has the appearance of a picture or sculpture, etc.). The artistic object serving as the support can be made of any material, preferably a slightly porous material: wood, plaster, resin, natural or reconstituted stone, etc. The coating obtained forms a patina which is not only conducting (and especially heat conducting in the case of a decorative radiator) but also and especially aesthetic, the colour and shade of which depend on the nature and amount of dopant(s) chosen. Furthermore, when the dopant is an expanded graphite, the patina, which is matt in the absence of additional treatment, becomes glossy when it is rubbed; the artistic object coated according to the invention then has a shiny appearance. The graphite used as dopant confers on the artistic object the appearance of bronze. In order to obtain a very deep colour, it is suitable to use a doped aqueous dispersion comprising more than 70 wt. % expanded graphite, based on solid matter; it is preferable in this case to form a plurality of layers of dispersion on the object, including a bonding layer as defined above.

Whatever the support used, the coating film or the sheet obtained according to the invention is permeable to liquids in the absence of additional treatment; it becomes much less permeable to liquids when it is rubbed, for example with the finger or optionally by means of a cloth or any polishing tool. This unexpected property makes it possible to produce, including from a single dispersion and in a single application, a coating film or a sheet having permeable areas (areas which have not been rubbed) and areas which are much less permeable (rubbed areas). Accordingly, in the process according to the invention, the layer of doped aqueous dispersion that is formed (it can be the only layer formed, or the finishing layer in the case of a plurality of layers) is advantageously rubbed wholly (that is to say over its entire surface) or partially (in certain areas only) once it has been consolidated.

According to a third technique, the step of forming the doped aqueous dispersion comprises the deposition of a layer of doped aqueous dispersion on a first support and the application of a second support to said layer. This deposition can be effected by means of a syringe.

Advantageously and according to the invention, the first support is a face of a heat emitting element and the second support is a face of a heat recovering and/or evacuating element. In particular, the heat emitting element and the heat recovering and/or evacuating element are components of a heat exchanger. In another application, the heat emitting element is a microprocessor—or more generally an electronic component—and the heat recovering and/or evacuating element is a heat sink element for a microprocessor—or more generally a heat sink element for an electronic component.

In this case, the solid obtained constitutes a thermal exchange interface which is effective, inexpensive and simple to produce. Because the doped aqueous dispersion is applied in the viscous state, it fits perfectly to the faces of the elements between which it is disposed. The thermal exchange surface between the elements and the resulting solid interface is therefore maximum. Furthermore, it has been found that the interface adheres to the faces of the elements.

With this third forming technique, the solid obtained according to the invention can also be an electric weld, which has the advantage of being carried out in the cold state, or a layer of thermally conducting, and also refractory, adhesive, which has the advantage that it does not contain any toxic, dangerous or non-recyclable product.

According to a fourth technique, the doped aqueous dispersion (that is to say at least one dispersion of the process) is formed by moulding. Moulding can be carried out by means of a factory mould or “in situ”, directly in the device that is ultimately to receive the solid, part of the device then acting as the mould.

This fourth technique permits, for example, the manufacture of an electrode, called a solid electrode (as opposed to the thin electrode defined above), a chemical reactor, an artistic object, etc. It will be noted that the expression “chemical reactor” denotes the site of a reaction, called a chemical reaction, which can be purely chemical or electrochemical or biochemical or bioelectrochemical.

Advantageously and according to the invention, within the scope of the manufacture of a chemical reactor or of a solid or thin electrode, the doped aqueous dispersion that is prepared can comprise at least one active agent chosen from: a reagent for a chemical reaction and/or for a redox reaction, a catalyst for a chemical reaction and/or for a redox reaction, an adsorbing agent for a physical adsorption reaction.

The catalyst is, for example, an enzyme. Enzymes are generally destroyed under the effect of heat, when the temperature exceeds 40° C. Because it can be carried out without a heating step, the process according to the invention allows enzymes to be incorporated into a reactor or a (solid or thin) electrode during manufacture of the reactor or electrode. Furthermore, the enzymes, which are fixed by the (hydrophilic) mica, are immobilized within the reactor or electrode in a three-dimensional hydrophilic matrix, which has advantages over all previous known devices—especially biosensors:
unlike the previous biosensors in which the enzymes are confined in a hydrophobic polymer matrix (which is very different from their natural medium), the hydrophilic mica matrix according to the invention protects the enzymes and promotes the diffusion of the chemical species to be analyzed. A biosensor produced from an electrode or a reactor according to the invention is therefore more durable and more reliable than the known biosensors having a polymer matrix; moreover, it offers a shorter response time;
unlike the previous biosensors in which the enzymes are adsorbed at the surface of an electrode and decompose rapidly, the three-dimensional mica matrix protects the enzymes, thus ensuring the durability and reliability of the resulting biosensor; furthermore, the biosensor according to the invention has increased sensitivity in so far as a larger amount of enzymes can be fixed thereto (only a very small amount of enzymes can be adsorbed in the previous biosensors);
unlike the biosensors in which the enzymes are imprisoned by a membrane, which are very tricky to produce, the production of a biosensor according to the invention is extremely simple and can readily be industrialized.

Furthermore, the amount of active agent(s) present in the chemical reactor or (solid or thin) electrode manufactured according to the invention corresponds to the amount introduced into the aqueous dispersion; it can therefore be precisely controlled (unlike in the known previous processes, in which a reactor is impregnated by immersing it in a solution of active agent, or in which enzymes are adsorbed at the surface of an electrode).

The invention relates also to a process for manufacturing a thermally and/or electrically conducting solid, characterized in combination by all or some of the features mentioned hereinabove and hereinbelow.

Other objects, features and advantages of the invention will become apparent from reading the following description, which proposes some non-limiting examples of the invention.

### EXAMPLE 1

A doped aqueous dispersion is prepared from 72.08 g of a 7.5% vermiculite dispersion, with which there are mixed 12.70 g of ground expanded natural graphite. The doped aqueous dispersion has the following characteristics:
mass of demineralized water: 66.67 g
mass of vermiculite: 5.41 g
mass of ground expanded natural graphite: 12.70 g
proportion by weight of vermiculite, based on solid matter: 29.87%
proportion by weight of graphite, based on solid matter: 70.13%
proportion by weight of solid matter in the doped aqueous dispersion: 21.36%
particle size analysis of the vermiculite powder: all the particles are between 3 and 180 μm, 15% of the particles are smaller than 10 μm, 50% of the particles are smaller than 30 μm, 70% of the particles are smaller than 50 μm, 90% of the particles are smaller than 80 μm
particle size analysis of the graphite powder: 90% of particles smaller than 45 μm, of which 50% of particles smaller than 15 μm, no particle larger than 200 μm.

This doped aqueous dispersion is fairly viscous (it hardly flows at all) without being totally pasty.

A plurality of samples of solid are produced from this dispersion. Each sample is produced by pouring a one-centimetre layer of dispersion into a mould and allowing it to dry in the open air and at ambient temperature.

The samples obtained are considered to be dry and are tested as soon as they are no longer malleable. Their thermal conductivity (in the direction of the thickness of the sample) is measured at ambient temperature by means of a hot disk thermal instrument.

The samples have an average thermal conductivity λ of 5 W·m⁻¹·k⁻¹.

### EXAMPLE 2

A doped aqueous dispersion is prepared according to Example 1. A layer of doped aqueous dispersion is formed between one face—called the exchange face—of a microprocessor and one face—also called the exchange face—of a heat sink element. To that end, the doped aqueous dispersion is deposited on the exchange face of the microprocessor by means of a syringe, in a sufficient amount that, once the heat sink element has been put in place, the dispersion covers said exchange face of the microprocessor. The heat sink element is placed on the dispersion, facing the microprocessor, by applying the exchange face of the heat sink element to the (viscous) dispersion and squashing the dispersion. According to a first method, the dispersion is allowed to dry at ambient temperature until consolidation thereof has been obtained and a thermal exchange interface is thus formed. Alternatively, according to a second method, the microprocessor is turned on in order to accelerate drying, to obtain so-called “in situ” consolidation and to have a thermal interface whose retention time is zero, the electronic circuit produced thus immediately being fully operational.

The inventors have found, by subsequently detaching the heat sink element and the microprocessor from the thermal exchange interface, that the latter adheres strongly to their respective exchange faces, over maximum contact surfaces: when it is still in the viscous state, the doped aqueous dispersion infiltrates into the rough areas of the exchange faces of the microprocessor and of the heat sink element; as it dries, it adheres to said exchange faces; the solid interface obtained fits to the faces very satisfactorily, filling the micro-spaces caused by imperfections in the opposing surfaces, which improves the transfer of heat.

### EXAMPLE 3

A doped aqueous dispersion is prepared according to Example 1. The doped aqueous dispersion is applied to a non-stick flat support by means of a brush, so as to form a layer having a thickness of about 1 mm. The dispersion is allowed to dry at ambient temperature until it consolidates. A sheet having a thickness of from 90 to 100 μm is obtained and is detached from the support. The electrical conductivity of the sheet is measured (in a direction parallel to the plane of the sheet) as a function of the temperature.

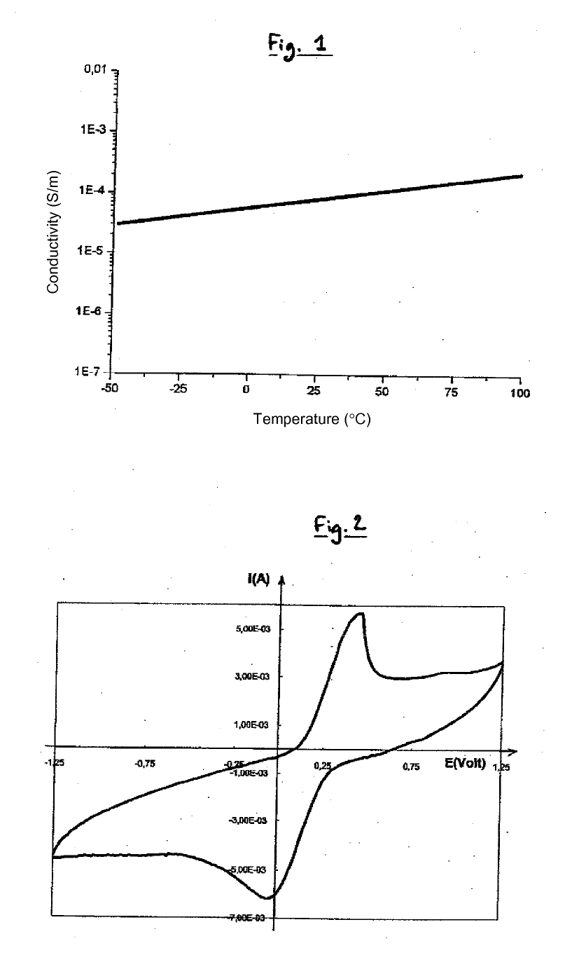

The results are recorded in the graph shown in FIG. 1. The average electrical conductivity measured is 1.E⁻⁴ S·m⁻¹. In view of these results, the sheet produced according to the invention can be described as “semi-metal” or “semi-conducting”.

### EXAMPLE 4

A strip cut from the sheet manufactured according to Example 3 is tested as a thin electrode, by cyclic voltammetry in an electrolytic solution of ferri-ferrocyanide and with a platinum secondary electrode and a reference electrode. Forward and reverse potential scanning is carried out at a constant speed of 50 mV/s between an anode limit of 1.25V and a cathode limit of −1.25V. The current is measured.

The results are recorded in the graph shown in FIG. 2. The presence of intensity peaks confirms the exchange of electrons between the electronic measuring circuit and the ionic solution, via the thin electrode. In addition, the electrode has a resistive component compatible with the envisaged applications of the chemical or bioelectrochemical sensor.

These results are all the more encouraging since the electrical connection between the strip (thin electrode) according to the invention and the measuring circuit was produced by means of a simple conductive clip (of the crocodile clip type). The connection is consequently punctual and not optimized. Greater electronic exchanges should be recorded by reducing the contact resistance between the electrode and the electrical contact (in the present case that of the measuring circuit), for example by applying the doped aqueous dispersion directly to one face, called the exchange face, of said contact so as to form a thin electrode which adheres to said contact over the whole of its exchange face.

### EXAMPLE 5

An aqueous dispersion is prepared according to Example 1 and is used to form, on one of the main faces of a piece of carbon foam used in the building industry, a fireproofing layer of conducting solid according to the invention having a thickness of the order of 320 μm. The face of the piece of carbon foam that is covered with the layer of conducting solid is exposed to the flame of a drip torch, and the variation in temperature on the opposite face of the piece of carbon foam is measured. The gain in protection provided by the fireproofing layer is expressed as the ratio of the time of exposure to the flame of a treated sample versus an untreated control sample necessary to result in perforation of the sample.

The gain in protection provided by the fireproofing protection for a carbon foam having a density of 2 kg/m³ is 3.6. Perforation of the untreated sample occurs after 315 seconds' exposure to the flame, whereas perforation of the fireproof sample occurs after 1160 seconds.

The gain in protection provided by the fireproofing protection for a carbon foam having a density of 30 kg/m³ is of the order of 2. Perforation of the untreated sample occurs after 8415 seconds, whereas perforation of the fireproof sample occurs after 2 hours and 20 minutes.

### EXAMPLE 6

Fireproofing tests similar to the tests described in Example 5 are carried out with pieces of cardboard-covered Placoplatre® [plasterboard] BA13 having a thickness of 13 mm used in the building industry.

The gain in protection provided by the fireproofing protection for a sheet of Placoplatre® BA13 is of the order of 5.5. Perforation of the untreated sheet occurs after 13 minutes, whereas perforation of the fireproof sheet occurs after 1 hour and 11 minutes.

1. A process for manufacturing a thermally and/or electrically conducting solid, in which:
at least one doped aqueous dispersion is prepared, said dispersion comprising a mica powder and at least one dopant powder, which powders are dispersed in a non-ionic aqueous liquid, each dopant being chosen from the graphites, with the exception of unexpanded expandable graphites, the mica representing at least 5 wt. % of the solid matter of the dispersion, the dopant(s) representing from 1 wt. % to 95 wt. % of the solid matter of the dispersion, the proportion of each dopant being chosen in dependence on the desired thermal and electrical conductivities,
each doped aqueous dispersion undergoes a forming operation, the proportion by weight of solid matter in the dispersion having been chosen so as to obtain, for the doped aqueous dispersion, a viscosity compatible with the forming technique used,
the doped aqueous dispersion is allowed to consolidate in terms of form, by evaporation at least of the aqueous phase of the dispersion liquid at a temperature below 80° C., in particular at ambient temperature.

2. The process as claimed in claim 1, wherein the mica powder and the dopant powder(s) are dispersed in the non-ionic aqueous medium so as to form the doped aqueous dispersion(s).

3. The process as claimed in claim 1, wherein the mica powder or the dopant powder(s) is(are) dispersed in the non-ionic aqueous medium so as to form an intermediate dispersion, and then the remaining powder(s) is(are) added to and mixed with said intermediate dispersion to form the doped aqueous dispersion(s).

4. The process as claimed in claim 1, wherein demineralized and/or deionized water is used as the dispersion liquid for each doped aqueous dispersion.

5. The process as claimed in claim 2, wherein each doped aqueous dispersion is prepared solely from demineralized and/or deionized water, mica powder and dopant powder(s).

6. The process as claimed in claim 1, wherein each mica is chosen from the vermiculites, the expanded vermiculites, the chemically delaminated vermiculites.

7. The process as claimed in claim 1, wherein, for each doped aqueous dispersion, at least one dopant is chosen from the expanded natural graphites and the synthetic graphites.

8. The process as claimed in claim 1, wherein, for each doped aqueous dispersion, at least one dopant is chosen from the group formed by the non-expandable graphites.

9. The process as claimed in claim 1, wherein the proportion by weight of solid matter in each doped aqueous dispersion is from 5 to 40%.

10. The process as claimed in claim 1, wherein the proportion by weight of mica in the solid matter of the doped aqueous dispersion is from 5 to 50%.

11. The process as claimed in claim 1, wherein each mica powder used is composed of particles having dimensions of from 1 to 200 μm.

12. The process as claimed in claim 11, wherein each mica powder used comprises at least 90% particles smaller than 90 μm and at least 50% particles smaller than 40 μm.

13. The process as claimed in claim 1, wherein each dopant powder used is composed of particles having dimensions of from 1 to 200 μm.

14. The process as claimed in claim 13, wherein each expanded graphite powder used comprises at least 90% particles smaller than 60 μm and at least 50% particles smaller than 30 μm.

15. The process as claimed in claim 1, wherein the step of consolidation by evaporation is carried out at ambient temperature.

16. The process as claimed in claim 1, wherein at least one doped aqueous dispersion is formed by application of at least one layer of doped aqueous dispersion to a support.

17. The process as claimed in claim 1, wherein at least one doped aqueous dispersion is formed by immersion of a support in the doped aqueous dispersion.

18. The process as claimed in claim 16, wherein a non-stick flat support is used, and wherein the solid obtained is a sheet.

19. The process as claimed in claim 18, wherein each doped aqueous dispersion prepared comprises at least 25 wt. % mica, based on solid matter.

20. The process as claimed in claim 16, wherein the solid obtained is a coating film which adheres to the support.

21. The process as claimed in claim 20, wherein:
there are prepared a plurality of doped aqueous dispersions, including at least one doped aqueous dispersion called a bonding dispersion, comprising a proportion of mica greater than 70 wt. %, based on solid matter, and a doped aqueous dispersion, called a finishing dispersion, comprising a proportion of dopant(s) greater than 70 wt. %, based on solid matter;
a plurality of layers of doped aqueous dispersions are formed in succession on the support, the first layer being formed with the bonding dispersion, the last layer being formed with the finishing dispersion.

22. The process as claimed in claim 20, wherein the support is an absorption face of a heliothermal converter, and wherein at least one dopant is a graphite, the coating film obtained constituting a selective coating.

23. The process as claimed in claim 20, wherein the support is an electrical contact, the coating film obtained constituting an electrode called a thin electrode.

24. The process as claimed in claim 20, wherein the support is an artistic object, especially a decorative radiator.

25. The process as claimed in claim 16, wherein the layer of doped aqueous dispersion formed is wholly or partially rubbed once it has consolidated.

26. The process as claimed in claim 1, wherein the forming step comprises the deposition of a layer of doped aqueous dispersion on a first support and the application of a second support to said layer.

27. The process as claimed in claim 26, wherein the first support is a face of a heat emitting element and the second support is a face of a heat recovering and/or evacuating element, and wherein the solid obtained constitutes a thermal exchange interface between those two elements.

28. The process as claimed in claim 27, wherein the heat emitting element is an electronic component, such as a microprocessor, and the heat recovering and/or evacuating element is a heat sink element for an electronic component.

29. The process as claimed in claim 26, wherein the heat emitting element and the heat recovering and/or evacuating element are components of a heat exchanger.

30. The process as claimed in claim 1, wherein at least one doped aqueous dispersion is formed by moulding.

31. The process as claimed in claim 30, wherein the solid obtained constitutes an electrode, called a solid electrode, or a chemical reactor.

32. The process as claimed in claim 23, wherein the doped aqueous dispersion prepared comprises at least one active agent chosen from: a reagent for a chemical reaction and/or for a redox reaction, a catalyst for a chemical reaction and/or for a redox reaction, an adsorption agent for a physical adsorption reaction.

33. The process as claimed in claim 32, wherein the catalyst is an enzyme.
